(19) United States
(12) Patent Application Publication
(10) Pub. No.: US 2022/0350196 A1
(43) Pub. Date: Nov. 3, 2022

(54) COLOR FILTER SUBSTRATE AND METHOD FOR MANUFACTURING SAME, DISPLAY PANEL, AND DISPLAY DEVICE

(71) Applicants: Ordos Yuansheng Optoelectronics Co., Ltd., Ordos, Inner Mongolia (CN); BOE Technology Group Co., Ltd., Beijing (CN)

(72) Inventors: Lei YAO, Beijing (CN); Yezhou FANG, Beijing (CN); Feng LI, Beijing (CN); Lei YAN, Beijing (CN); Kai LI, Beijing (CN); Chenglong WANG, Beijing (CN); Teng YE, Beijing (CN); Lin HOU, Beijing (CN); Xiaofang LI, Beijing (CN)

(21) Appl. No.: 17/442,102

(22) PCT Filed: Dec. 2, 2020
(86) PCT No.: PCT/CN2020/133370

§ 371 Date: Sep. 22, 2021

(51) Int. Cl. G02F 1/1335; G02B 5/22; G02B 1/00

(52) U.S. Cl. CPC G02F 1/133516; G02F 1/133512; G02B 5/22; G02B 1/002; G06F 1/163

(57) ABSTRACT

The present disclosure discloses a color filter substrate and a method for manufacturing the same, a display panel, and a display device, which relates to the field of display technologies. A black matrix layer in the color filter substrate includes a first film layer and a second film layer. As a material of the first film layer is different from a material of the second film layer, at least one of the first film layer and the second film layer is prepared without using a resin adhesive, and then the resin adhesive remaining in at least one through-hole of the first through-holes of the first film layer and the second through-holes of the second film layer can be reduced, and the display effect of the display device is ensured. In addition, reflectivity of the first film layer is relatively large and optical density of the second film layer is relatively large, which ensures that the color filter substrate according to the embodiments of the present disclosure can meet the design requirement of the black matrix layer.

### CROSS-REFERENCE TO RELATED APPLICATION

The application is a US national phase application based on PCT/CN2020/133370, filed on Dec. 2, 2020, the disclosure of which is herein incorporated by reference in its entirety.

### TECHNICAL FIELD

The present disclosure relates to the field of display technologies, and in particular to a color filter substrate and a method for manufacturing the same, a display panel, and a display device.

### BACKGROUND

With the development of technologies, the requirements of users on the pixel density of display devices are higher and higher.

### SUMMARY

The present disclosure provides a color filter substrate and a method for manufacturing the same, a display panel, and a display device. The technical solutions are provided as follows:

In an aspect, a color filter substrate is provided. The color filter substrate includes:

a base substrate;

a black matrix layer disposed on the base substrate, wherein the black matrix layer includes a first film layer and a second film layer that are stacked in a direction going away from the base substrate, wherein the first film layer is provided with a plurality of first through-holes, and the second film layer is provided with a plurality of second through-holes in one-to-one correspondence with the plurality of first through-holes, the second through-hole being communicated with the corresponding first through-hole; and

a plurality of color resist blocks, wherein each of the color resist blocks is disposed in one second through-hole and the corresponding first through-hole;

wherein a material of the first film layer is different from a material of the second film layer, reflectivity of the first film layer is less than a reflectivity threshold, and an optical density of the second film layer is greater than an optical density threshold.

Optionally, an orthographic projection of the second through-hole on the base substrate covers an orthographic projection of the corresponding first through-hole on the base substrate.

Optionally, the reflectivity threshold is 10%, and the optical density threshold is 4.0.

Optionally, the material of the first film layer includes an oxide material; and the material of the second film layer includes a metal material.

Optionally, the material of the first film layer includes molybdenum oxide; and the material of the second film layer includes at least one of molybdenum, aluminum, titanium, and copper.

Optionally, a thickness of the first film layer is ranged from 50 nm to 60 nm; and a thickness of the second film layer is ranged from 120 nm to 200 nm.

In another aspect, a method for manufacturing a color filter substrate is provided. The method includes:

providing a base substrate;

forming a black matrix layer and a plurality of color resist blocks on a side of the base substrate;

wherein the black matrix layer includes a first film layer and a second film layer that are stacked in a direction going away from the base substrate, wherein the first film layer is provided with a plurality of first through-holes, the second film layer is provided with a plurality of second through-holes in one-to-one correspondence with the plurality of first through-holes, the second through-hole being communicated with the corresponding first through-hole, and each of the color resist blocks is disposed in one second through-hole and the corresponding first through-hole; wherein a material of the first film layer is different from a material of the second film layer, reflectivity of the first film layer is less than a reflectivity threshold, and an optical density of the second film layer is greater than an optical density threshold.

Optionally, forming the black matrix layer on the side of the base substrate includes:

forming a first material layer on the side of the base substrate;

forming a second material layer on a side of the first material layer distal from the base substrate; and

acquiring the first film layer and the second film layer by performing a patterning process on the first material layer and the second material layer.

Optionally, an etching solution adopted in the patterning process includes nitric acid, acetic acid, and phosphoric acid.

Optionally, the reflectivity threshold is 10%, and the optical density threshold is 4.0.

Optionally, the material of the first film layer includes an oxide material; and the material of the second film layer includes a metal material.

Optionally, the material of the first film layer includes molybdenum oxide; and the material of the second film layer includes at least one of molybdenum, aluminum, titanium, and copper.

Optionally, a thickness of the first film layer is ranged from 50 nm to 60 nm; and a thickness of the second film layer is ranged from 120 nm to 200 nm.

In another aspect, a display panel is provided. The display panel includes: an array substrate, the color filter substrate as defined in the above aspect, and a liquid crystal layer disposed between the array substrate and the color filter substrate.

In another aspect, a display device is provided. The display device includes: a drive circuit and the display panel as defined in the above aspect;

wherein the drive circuit is connected with an array substrate in the display panel, and is configured to provide a drive signal for the array substrate.

Optionally, the display device may be a wearable display device.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of pixels in a display device according to an embodiment of the present disclosure;

FIG. 2 is a schematic diagram of the pixels in another display device according to an embodiment of the present disclosure;

FIG. 3 is a schematic diagram of a black matrix layer in the related art.

FIG. 4 is a schematic diagram of the display effect of a display device in the related art;

FIG. 5 is a schematic diagram of pixels of a display device in the related art:

FIG. 6 is a schematic structural diagram of a color filter substrate according to an embodiment of the present disclosure;

FIG. 7 is a schematic diagram of a base substrate and a black matrix layer according to an embodiment of the present disclosure;

FIG. 8 is a schematic diagram of another base substrate and another black matrix layer according to an embodiment of the present disclosure;

FIG. 9 is a flow chart of a method for manufacturing a color filter substrate according to an embodiment of the present disclosure;

FIG. 10 is a flow chart of another method for manufacturing a color filter substrate according to an embodiment of the present disclosure;

FIG. 11 is a schematic diagram of forming a first material layer and a second material layer according to an embodiment of the present disclosure;

FIG. 12 is a schematic diagram of a plurality of photoresist patterns acquired after exposing photoresist according to an embodiment of the present disclosure;

FIG. 13 is a schematic diagram of performing etching on a first film layer and a second film layer according to an embodiment of the present disclosure;

FIG. 14 is a schematic structural diagram of a display panel according to an embodiment of the present disclosure; and

FIG. 15 is a schematic structural diagram of a display device according to an embodiment of the present disclosure.

### DETAILED DESCRIPTION

For clearer description of the objectives, technical solutions, and advantages in the present disclosure, the embodiments of the present disclosure are described in further detail hereinafter with reference to the accompanying drawings.

In the related art, a display device includes an array substrate and a color filter substrate which are oppositely arranged. The color filter substrate includes a black matrix layer and a plurality of color resist blocks of different colors. The black matrix layer has a plurality of through-holes, and each through-hole is disposed with one color resist block. The black matrix layer may be prepared by a resin adhesive.

However, the larger the pixel density of the display device is, the smaller the pixel size is, which results in the smaller the size of the through-holes in the black matrix layer, and the resin adhesive may easily remain in the through-hole of the black matrix layer, thus the display effect of the display device is poor.

Wearable display device develops rapidly in recent years and has very broad application prospects. However, in the experience of the wearable display device, due to the magnification effect of the magnifying glass in the wearable display device, users may see many horizontal and vertical dark lines, which affects the experience effect. Because the resolution of the wearable display device is insufficient and the display plane of the display panel in the wearable display device is close to human eyes, users may see pixels of a display screen. To improve the display effect of the wearable display device, manufacturers of the wearable display device have put forward higher and higher requirements for pixel density (pixels per inch, PPI) of the display panel.

To better meet the requirements of users, the PPI of the display panel of the wearable display device is constantly increasing, and the display panel with 800 PPI to 1000 PPI is currently in mass production. However, the pixel density of the display panel of the wearable display device still needs to be increased continuously to further improve the display effect of the wearable display device.

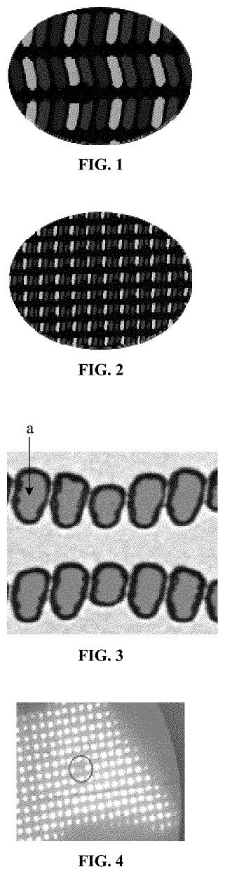

In FIG. 1, the pixel density of the display panel may be 400 PPI. The pixel density of the display panel in FIG. 2 may be 1000 PPI. From FIG. 1 and FIG. 2, the lower the pixel density is, the smaller the number of pixels per unit is; and the higher the pixel density is, the larger the number of pixels per unit is.

As pixel density continues to increase, pixel size continues to decrease. For a product with a pixel density of 1000 PPI, the pixel size is as low as about 8 μm (micron). Referring to FIG. 3, the distance between two adjacent through-holes a in a black matrix (BM) layer is relatively small, and thus a resin adhesive for preparing a black matrix layer 102 may remain in the through-holes. As a result, the light emitted from the through-holes is affected by the residual resin adhesive, and the display effect of the display device is poor. For example, referring to FIG. 4 and FIG. 5, the display panel of the display device has dark spots and stained pixels.

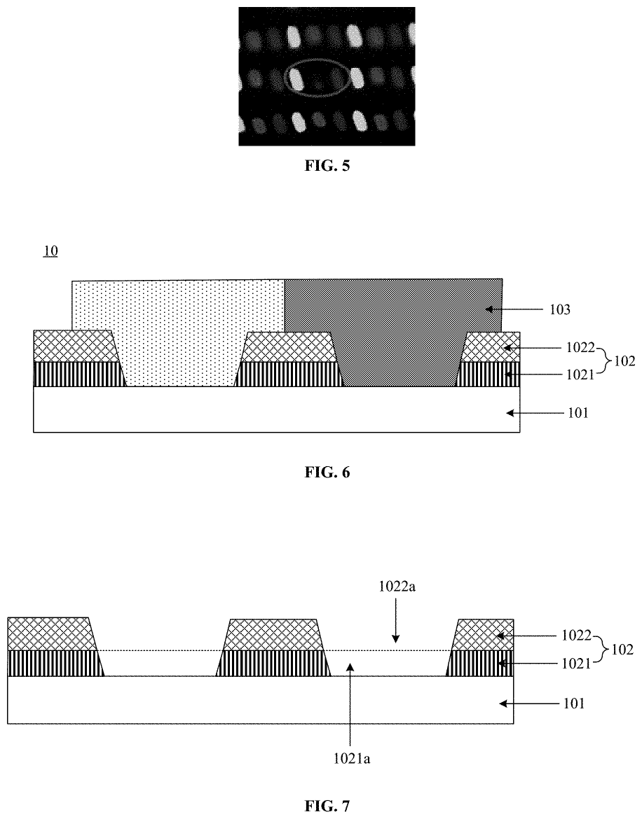

According to the embodiments of the present disclosure, a color filter substrate is provided, which can solve the technical problem of the poor display effect of the display device in the related art. Referring to FIG. 6, the color filter substrate 10 may include a base substrate 101, a black matrix layer 102, and a plurality of color resist blocks 103.

The black matrix layer 102 may be disposed on the base substrate 101, and the black matrix layer 102 may include a first film layer 1021 and a second film layer 1022 that are stacked in a direction going away from the base substrate 101. The first film layer 1021 may be provided with a plurality of first through-holes (not shown in FIG. 1), and the second film layer 1022 may be provided with a plurality of second through-holes (not shown in FIG. 1) in one-to-one correspondence with the plurality of first through-holes, each second through-hole is communicated with the corresponding first through-hole. Each color resist block 103 is disposed in one second through-hole and the corresponding first through-hole.

A material of the first film layer 1021 may be different from a material of the second film layer 1022, reflectivity of the first film layer 1021 may be less than a reflectivity threshold, and an optical density of the second film layer 1022 may be greater than an optical density threshold.

The materials of the first film layer 1021 and the second film layer 1022 included in the black matrix layer 102 in the color filter substrate 10 are different, such that at least one of the first film layer 1021 and the second film layer 1022 is not prepared by a resin adhesive. Therefore, the resin adhesive remaining in the through-holes of the black matrix layer 102 can be reduced (the resin adhesive will not remain in the through-holes of the film layer which is not prepared by the resin adhesive), and thus the display effect of the display device can be improved.

Optionally, neither the material of the first film layer 1021 nor the material of the second film layer 1022 includes the resin adhesive. i.e., the first film layer 1021 and the second film layer 1022 are not prepared by the resin adhesive. Therefore, even if the sizes of the through-holes (for example, the first through-holes of the first film layer and the second through-holes of the second film layer) in the black matrix layer 102 are small, the resin adhesive remaining in the first through-holes of the first film layer 1021 and the second through-holes of the second film layer 1022 can be avoided, and thus the display effect of the display device is ensured.

In addition, the reflectivity of the first film layer 1021 in the black matrix layer 102 may be relatively large, which can meet the reflectivity design requirements of the black matrix layer 102. The optical density (OD) of the second film layer 1022 in the black matrix layer 102 may be relatively large, which can meet the optical density design requirements of the black matrix layer 102. That is, the color film substrate 10 according to the embodiments of the present disclosure can improve the display effect of the display device in a precondition of meeting the design requirements of the black matrix layer 102.

In summary, according to the embodiments of the present disclosure, a color filter substrate is provided. A black matrix layer in the color filter substrate includes a first film layer and a second film layer. As a material of the first film layer is different from a material of the second film layer, at least one of the first film layer and the second film layer can be prepared without using a resin adhesive, and then the resin adhesive remaining in at least one through-hole of the first through-holes of the first film layer and the second through-holes of the second film layer can be reduced and the display effect of the display device is ensured. In addition, reflectivity of the first film layer is relatively large and optical density of the second film layer is relatively large, which ensures that the color filter substrate according to the embodiments of the present disclosure can meet the design requirement of the black matrix layer.

Optionally, an orthographic projection of the second through-hole on the base substrate 101 may cover an orthographic projection of the corresponding first through-hole on the base substrate 101.

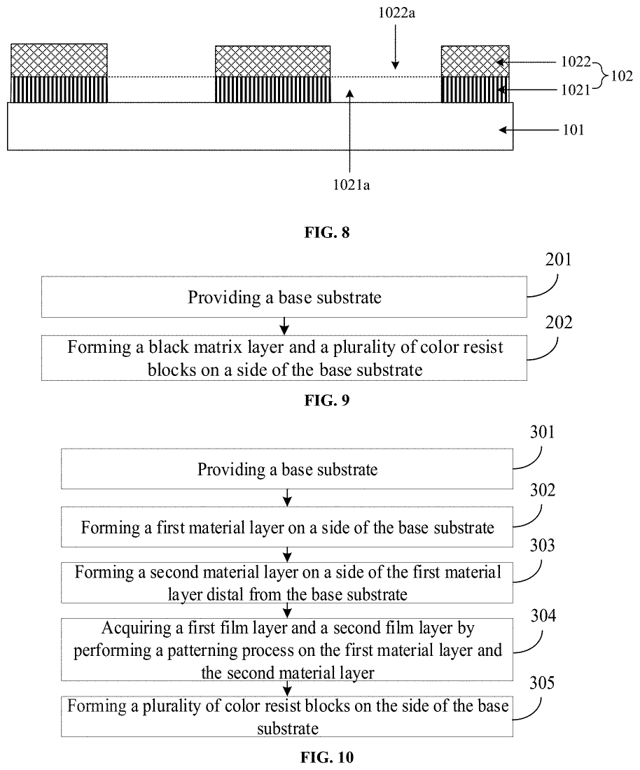

Exemplarily, referring to FIG. 7, the area of the orthographic projection of the second through-hole on the base substrate 101 may be larger than the area of the orthographic projection of the corresponding first through-hole on the base substrate 101. Alternatively, referring to FIG. 8, the area of the orthographic projection of the second through-hole on the base substrate 101 may be equal to the area of the orthographic projection of the corresponding first through-hole on the base substrate 101.

Optionally, the reflectivity threshold may be 10%, and the optical density threshold may be 4.0. That is, the reflectivity of the first film layer 1021 may be greater than 10%, and the optical density of the second film layer 1022 may be larger than 4.0.

In the embodiments of the present disclosure, the material of the first film layer 1021 may include an oxide material. Optionally, the material of the first film layer 1021 may include molybdenum oxide (MoOx). The material of the second film layer 1022 may include a metal material. Optionally, the material of the second film layer 1022 may include at least one of molybdenum (Mo), aluminum (Al), titanium (Ti), and copper (Cu). For example, the material of the second film layer 1022 may be molybdenum.

As a new type of low reflective material, molybdenum oxide has been currently used in part of reflective products. The following Table 1 is obtained by performing actual verification tests on the thickness of the first film layer 1021 prepared by molybdenum oxide and the reflectivity of the film layer.

TABLE 1

| | Thickness of film layer | | | | | |
|---|---|---|---|---|---|---|
| | 30 nm | 40 nm | 50 nm | 55 nm | 60 nm | 70 nm |
| Reflectivity | 23.1% | 10.87% | 7.33% | 7.37% | 7.63% | 10.6% |
| of film layer | | | | | | |

Referring to Table 1, the reflectivity of the first film layer 1021 may reduce gradually at first and then gradually increase with the continuous increasing of the thickness of the first film layer 1021. When the thickness of the first film layer 1021 is ranged from 50 nm (nanometer) to 60 nm, the reflectivity of the first film layer 1021 is extremely low, which may be far smaller than the reflectivity of metallic molybdenum (the reflectivity of molybdenum is 45%). Thus, the first film layer 1021 prepared by the molybdenum oxide may be an extremely ideal reflective layer.

However, as the optical density of the first film layer 1021 prepared by molybdenum oxide is only about 1.0, in the case that the black matrix layer 102 only includes the first film layer 1021 prepared by molybdenum oxide, the black matrix layer 102 may not meet the design requirement that the optical density in each region of the display device is greater than 4.0.

In the embodiments of the present disclosure, the black matrix layer 102 may include a second film layer 1022 prepared by molybdenum with a relatively high optical density. The actual verification tests performed on the second film layer 1022 prepared by molybdenum, and it is determined that the optical density in each region of the display device is greater than 4.0 when the thickness of the second film layer 1022 is greater than or equal to 120 nm, which may meet the design requirement of the black matrix layer 102.

However, the reflectivity of the second film layer 1022 prepared by molybdenum is as high as 60% or more. Therefore, in the case that the black matrix layer 102 only includes the second film layer 1022 prepared by molybdenum, the black matrix layer 102 may not meet the design requirement that the reflectivity of the display device is less than 10%.

In the embodiments of the present disclosure, the black matrix layer 102 may be a double-layer structure of the first film layer 1021 and the second film layer 1022, the first film layer 1021 is prepared by molybdenum oxide, and the second film layer 1022 is prepared by molybdenum. The first film layer 1021 may meet the design requirement that the reflectivity is less than the reflectivity threshold, and the second film layer 1022 may meet the design requirement that the optical density is greater than the optical density threshold.

Exemplarily, in the case that the first film layer 1021 included in the black matrix layer 102 is prepared by molybdenum oxide, the thickness of the first film layer 1021 is ranged from 50 nm to 60 nm, the second film layer 1022 included in the black matrix layer 102 is prepared by molybdenum, and the thickness of the second film layer 1022 is ranged from 120 nm to 200 nm, after experimental verification tests, it is determined that the reflectivity of the black matrix layer 102 is less than 10%, and the optical density is 7.0. That is, both the reflectivity and the optical density of the black matrix layer 102 meet the design requirements.

Thus, the thickness of the first film layer 1021 included in the black matrix layer 102 may be ranged from 50 nm to 60 nm. In addition, the thickness of the second film layer 1022 included in the black matrix layer 102 may be ranged from 120 nm to 200 nm.

In the embodiments of the present disclosure, the color of each color resist block 103 may be one of red (R), green (G), and blue (B). In addition, each color resist block 103 may be used to transmit light of the same color as the color resist block 103.

In summary, according to the embodiments of the present disclosure, a color filter substrate is provided. A black matrix layer in the color filter substrate includes a first film layer and a second film layer. As a material of the first film layer is different from a material of the second film layer, at least one of the first film layer and the second film layer can be prepared without using a resin adhesive, and then the resin adhesive remaining in at least one through-hole of the first through-holes of the first film layer and the second through-holes of the second film layer can be reduced and the display effect of the display device is ensured. In addition, reflectivity of the first film layer is relatively large and optical density of the second film layer is relatively large, which ensures that the color filter substrate according to the embodiments of the present disclosure can meet the design requirement of the black matrix layer.

FIG. 9 is a flow chart of a method for manufacturing a color filter substrate according to an embodiment of the present disclosure. Referring to FIG. 9, the method may include the following steps.

In step 201, a base substrate is provided.

In the embodiments of the present disclosure, a base substrate 101 may be first acquired. The base substrate 101 may be a glass substrate.

In step 202, a black matrix layer and a plurality of color resist blocks are formed on a side of the base substrate.

In the embodiments of the present disclosure, after the base substrate 101 is acquired, a black matrix layer 102 and a plurality of color resist blocks 103 may be formed on a side of the base substrate 101. The black matrix layer 102 may include a first film layer 1021 and a second film layer 1022 that are stacked in a direction going away from the base substrate 101. The first film layer 1021 may be provided with a plurality of first through-holes, and the second film layer 1022 may be provided with a plurality of second through-holes in one-to-one correspondence with the plurality of first through-holes. Each of the second through-holes may be communicated with one corresponding first through-hole. Each of the color resist blocks 103 may be disposed in one second through-hole and the corresponding first through-hole.

A material of the first film layer 1021 may be different from a material of the second film layer 1022, reflectivity of the first film layer 1021 may be less than a reflectivity threshold, and an optical density of the second film layer 1022 may be greater than an optical density threshold.

As the materials of the first film layer 1021 and the second film layer 1022 included in the black matrix layer 102 in the prepared color filter substrate are different, at least one of the first film layer 1021 and the second film layer 1022 may be prepared without a resin adhesive. Therefore, the resin adhesive remaining in the through-holes of the black matrix layer 102 is reduced (the resin adhesive will not remain in the through-holes which are not prepared by the resin adhesive), and thus the display effect of the display device can be improved.

Optionally, neither the material of the first film layer 1021 nor the material of the second film layer 1022 includes the resin adhesive, i.e., neither the first film layer 1021 nor the second film layer 1022 are prepared by the resin adhesive. In this case, when the first film layer 1021 and the second film layer 1022 are prepared, the resin adhesive remaining in the first through-holes of the first film layer 1021 and the second through-holes of the second film layer 1022 can be avoided, and thus the display effect of the display device is ensured.

In addition, the reflectivity of the first film layer 1021 in the black matrix layer 102 may be relatively large, which can meet the reflectivity design requirements of the black matrix layer 102. The optical density of the second film layer 1022 in the black matrix layer 102 may be relatively large, which can meet the optical density design requirements of the black matrix layer 102. That is, the color film substrate 10 according to the present disclosure can improve the display effect of the display device in a precondition of meeting the design requirements of the black matrix layer 102.

In summary, according to the embodiments of the present disclosure, a method for manufacturing a color filter substrate is provided. The materials of a first film layer and a second film layer included in a black matrix layer in the color filter substrate prepared by the method are different, and then at least one of the first film layer and the second film layer can be prepared without using a resin adhesive. Therefore, the resin adhesive remaining in at least one through-hole of the first through-holes of the first film layer and the second through-holes of the second film layer can be reduced, and the display effect of the display device is ensured. In addition, reflectivity of the first film layer is relatively large and optical density of the second film layer is relatively large, and then it can be determined that the color filter substrate according to the embodiments of the present disclosure can meet the design requirement of the black matrix layer.

FIG. 10 is a flow chart of another method for manufacturing a color filter substrate according to an embodiment of the present disclosure. Referring to FIG. 10, the method may include the following steps.

In step 301, a base substrate is provided.

In the embodiments of the present disclosure, a base substrate 101 may be first acquired. The base substrate 101 may be a glass substrate.

In step 302, a first material layer is formed on a side of the base substrate.

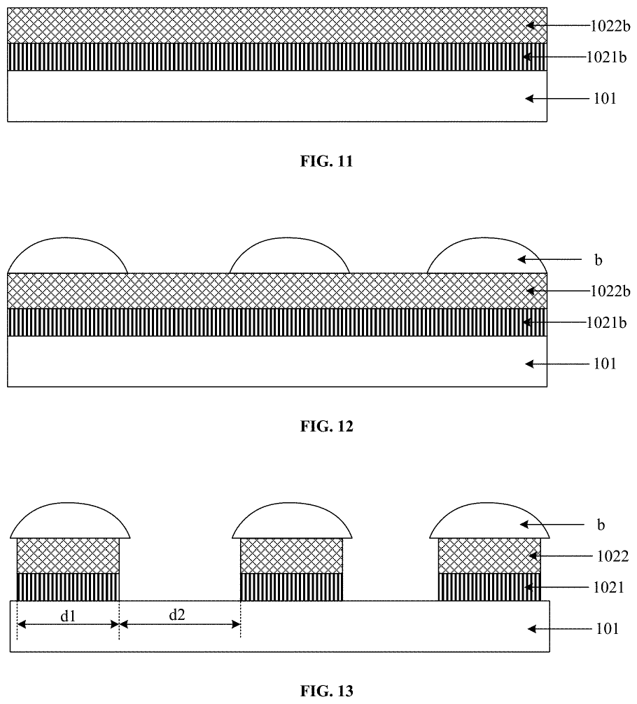

In the embodiments of the present disclosure, after the base substrate 101 is acquired, referring to FIG. 11, a first material layer 1021B may be formed on the side of the base substrate 101. Reflectivity of the first material layer 1021b may be less than a reflectivity threshold. The reflectivity threshold may be 10%.

Optionally, a material of the first material layer 1021b may include an oxide material. For example, the material of the first film layer 1021b may include molybdenum oxide.

Optionally, a thickness of the first material layer 1021b is ranged from 50 nm to 60 mm.

In step 303, a second material layer is formed on a side of the first material layer distal from the base substrate.

In the embodiments of the present disclosure, after the first material layer 1021b is formed on the side of the base substrate 101, referring to FIG. 11, a second material layer 1022b may be formed on a side of the first material layer 1021b distal from the base substrate 101. An optical density of the second material layer 1022b may be greater than an optical density threshold. The optical density threshold may be 4.0.

Optionally, a material of the second material layer 1022b may include a metal material. For example, the material of the second material layer 1022b may include at least one of molybdenum (Mo), aluminum (Al), titanium (Ti), and copper (Cu).

Optionally, a thickness of the second material layer 1022b may be ranged from 120 nm to 200 nm.

In step 304, a first film layer and a second film layer are acquired by performing a patterning process on the first material layer and the second material layer.

In the embodiments of the present disclosure, the first film layer 1021 is formed by the first material layer 1021b, and the second film layer 1022 is formed by the second material layer 1022b. That is, a material of the first film layer 1021 may include an oxide material, and a material of the second film laver 1022 may include a metal material. Exemplarily, the material of the first film layer 1021 includes molybdenum oxide, and the material of the second film layer 1022 includes at least one of molybdenum (Mo), aluminum (Al), titanium (Ti), and copper (Cu). A thickness of the first film layer 1021 may be ranged from 50 nm to 60 nm, and a thickness of the second film layer 1022 may be ranged from 120 nm to 200 nm.

Referring to FIG. 12 to FIG. 14, the patterning process may include processes such as photo resist (PR) coating, exposing, developing, etching, and photoresist stripping. FIG. 12 is a schematic diagram of a plurality of photoresist patterns b acquired after exposing the photoresist by a mask, and FIG. 7 is a schematic diagram of the first material layer and the second material layer after etching. In addition, referring to FIG. 8, it is a schematic diagram after the photoresist is stripped. The photoresist may be a positive photoresist, and the mask used for exposure may be a positive mask.

The first film layer 1021 (prepared by molybdenum oxide) and the second film layer 1022 (prepared by molybdenum) may be acquired by one etching. Optionally, the etching may be wet etching or dry etching. In the case that the etching is wet etching, the etching solution used in the etching may include HNO₃, CH₃COOH, and H₃PO₄.

In the case that the etching is wet etching, referring to FIG. 13, the area of the orthographic projection of the developed photoresist on the base substrate 101 may be larger than the area of the orthographic projection of the etched first material layer 1021b (the etched first material layer 1021b is the first film layer 1021) on the base substrate 101, and larger than the area of the orthographic projection of the etched second material layer 1022b (the etched second material layer 1022b is the second film layer 1022) on the base substrate 101.

As the first film layer 1021 (prepared by molybdenum oxide) and the second film layer 1022 (prepared by molybdenum) may be acquired by one etching, the black matrix layer 102 may be prepared by only one mask process. That is, compared with the preparation process of the black matrix layer 102 using a resin adhesive in the related art, the preparation process of the black matrix layer 102 according to the embodiments of the present disclosure has not increased, and the preparation is relatively simple.

In the embodiments of the present disclosure, when the gate pattern in a peripheral area of an array substrate is prepared, the processing capability of an exposing machine may reach the limit, for example, a width of the prepared gate pattern may be 2.2 μm (micrometer), and a distance between two adjacent gate patterns may be 3.3 μm. Therefore, in the embodiments of the present disclosure, in the case that the black matrix layer 102 is prepared by the method for preparing the gate pattern with the exposing machine, the black matrix layer 102 may also satisfy the above design of size limit (for example, referring to FIG. 13, a width d1 of the film layer pattern of the first film layer 1021 and the second film layer 1022 may be 2.2 μm, and a distance d2 between two adjacent film layer patterns may be 3.3 μm), such that the display device can reach the requirement of 1000 PPI. In addition, the size of each pixel may be less than 8 μm.

In addition, referring to FIG. 7 and FIG. 8, the formed first film layer 1021 may be provided with a plurality of first through-holes 1021a, and the formed second film layer 1022 may be provided with a plurality of second through-holes 1022a in one-to-one correspondence with the plurality of first through-holes 1021a, wherein the second through-hole 1022a is communicated with the corresponding first through-hole 1021a.

In step 305, a plurality of color resist blocks are formed on the side of the base substrate.

In the embodiments of the present disclosure, color resist blocks 103 may be formed in the first through-holes of the first film layer 1021 and the second through-holes of the second film layer 1022 of the black matrix layer 102. For example, one color resist block 103 may be provided in each second through-hole 1022a and the corresponding first through-hole 1021a.

The color of each color resist block 103 may be one of red (R), green (G), and blue (B). In addition, each color resist block 103 may be used to transmit light of the same color as the color resist block 103.

In summary, according to the embodiments of the present disclosure, a method for preparing a color film substrate is provided. In the color filter substrate prepared by the method, the black matrix layer includes a first film layer and a second film layer. As a material of the first film layer is different from a material of the second film layer, at least one of the first film layer and the second film layer can be prepared without using a resin adhesive, and then the resin adhesive remaining in at least one through-hole of the first through-holes of the first film layer and the second through-holes of the second film layer can be reduced and the display effect of the display device is ensured. In addition, reflectivity of the first film layer is relatively large and optical density of the second film layer is relatively large, which ensures that the color filter substrate prepared according to the present disclosure can meet the design requirement of the black matrix layer.

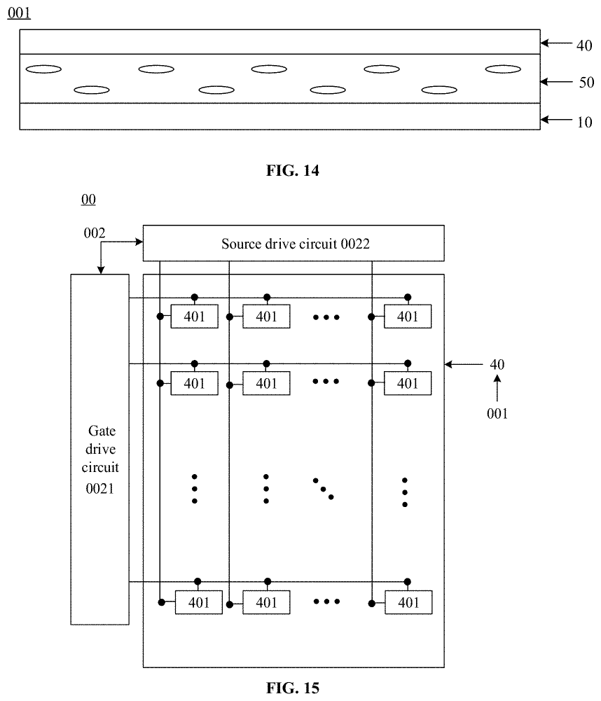

FIG. 14 is a schematic structural diagram of a display panel according to an embodiment of the present disclosure. Referring to FIG. 14, the display panel 001 may include an array substrate 40, the color filter substrate 10 according to the above embodiments, and a liquid crystal layer 50 disposed between the array substrate 40 and the color filter substrate 10. The liquid crystal molecules in the liquid crystal layer 50 may be deflected under the effect of the common electrodes and pixel electrodes included in the array substrate 40 to realize the image display.

Optionally, the display panel 001 may be a low-temperature poly-silicon (LTPS) display panel.

FIG. 15 is a schematic structural diagram of a display device according to an embodiment of the present disclosure. Referring to FIG. 15, the display device 00 may include a drive circuit 002 and the display panel 001 according to the above embodiments. The drive circuit 002 may be connected with an array substrate 40 in the display panel 001 to provide a drive signal for the array substrate 40.

Referring to FIG. 15, the drive circuit 002 may include a gate drive circuit 0021 and a source drive circuit 0022. The array substrate 40 may include a plurality of pixels 401 arranged in an array. The gate drive circuit 0021 may be connected with each row of the pixels 401 in the array substrate 40 through gate lines to provide gate drive signals for each row of the pixels 401. The source gate circuit 0022 may be connected with each column of the pixels 401 in each column of the array substrate 40 through data lines to provide data signals for each column of the pixels 401.

Optionally, the display device may be a wearable display device. For example, the display device may be a virtual reality (VR) device or an augmented reality (AR) device.

Optionally, the display device may be any products or components with a display function and a fingerprint identification function, such as a liquid crystal display device, an electronic paper, a mobile phone, a tablet computer, a television, a display, a notebook computer, a digital photo frame, or a navigator.

Described above are merely exemplary embodiments of the present disclosure, and are not intended to limit the present disclosure. Within the spirit and principles of the present disclosure, any modifications, equivalent replacements, improvements, and the like are within the protection scope of the present disclosure.

1. A color filter substrate, comprising:
a base substrate;
a black matrix layer disposed on the base substrate, wherein the black matrix layer comprises a first film layer and a second film layer that are stacked in a direction going away from the base substrate, wherein the first film layer is provided with a plurality of first through-holes, and the second film layer is provided with a plurality of second through-holes in one-to-one correspondence with the plurality of first through-holes, the second through-hole being communicated with the corresponding first through-hole; and
a plurality of color resist blocks, wherein each of the color resist blocks is disposed in one second through-holes and the corresponding first through-hole;
wherein a material of the first film layer is different from a material of the second film layer, reflectivity of the first film layer is less than a reflectivity threshold, and an optical density of the second film layer is greater than an optical density threshold.

2. The color filter substrate according to claim 1, wherein an orthographic projection of the second through-hole on the base substrate covers an orthographic projection of the corresponding first through-hole on the base substrate.

3. The color filter substrate according to claim 1, wherein the reflectivity threshold is 10%, and the optical density threshold is 4.0.

4. The color filter substrate according to claim 1, wherein the material of the first film layer comprises an oxide material; and the material of the second film layer comprises a metal material.

5. The color filter substrate according to claim 4, wherein the material of the first film layer comprises molybdenum oxide; and the material of the second film layer comprises at least one of molybdenum, aluminum, titanium, and copper.

6. The color filter substrate according to claim 1, wherein a thickness of the first film layer is ranged from 50 nm to 60 nm; and a thickness of the second film layer is ranged from 120 nm to 200 nm.

7. A method for manufacturing a color filter substrate, comprising:
providing a base substrate;
forming a black matrix layer and a plurality of color resist blocks on a side of the base substrate; and
wherein the black matrix layer comprises a first film layer and a second film layer that are stacked in a direction going away from the base substrate, wherein the first film layer is provided with a plurality of first through-holes, the second film layer is provided with a plurality of second through-holes in one-to-one correspondence with the plurality of first through-holes, the second through-hole being communicated with the corresponding first through-hole, and each of the color resist blocks is disposed in one second through-hole and the corresponding first through-hole; wherein a material of the first film layer is different from a material of the second film layer, reflectivity of the first film layer is less than a reflectivity threshold, and an optical density of the second film layer is greater than an optical density threshold.

8. The manufacturing method according to claim 7, wherein said forming the black matrix layer on the side of the base substrate comprises:
forming a first material layer on the side of the base substrate;
forming a second material layer on a side of the first material layer distal from the base substrate; and
acquiring the first film layer and the second film layer by performing a patterning process on the first material layer and the second material layer.

9. The manufacturing method according to claim 8, wherein an etching solution adopted in the patterning process comprises nitric acid, acetic acid, and phosphoric acid.

10. The manufacturing method according to claim 7, wherein the reflectivity threshold is 10%, and the optical density threshold is 4.0.

11. The manufacturing method according to claim 7, wherein the material of the first film layer comprises an oxide material; and the material of the second film layer comprises a metal material.

12. The manufacturing method according to claim 11, wherein the material of the first film layer comprises molybdenum oxide; and the material of the second film layer comprises at least one of molybdenum, aluminum, titanium, and copper.

13. The manufacturing method according to claim 7, wherein a thickness of the first film layer is ranged from 50 nm to 60 nm; and a thickness of the second film layer is ranged from 120 nm to 200 nm.

14. A display panel, comprising: an array substrate, a color filter substrate, and a liquid crystal layer disposed between the array substrate and the color filter substrate;
wherein the color filter substrate comprises:
a base substrate;
a black matrix layer disposed on the base substrate, wherein the black matrix layer comprises a first film layer and a second film layer that are stacked in a direction going away from the base substrate, wherein the first film layer is provided with a plurality of first through-holes, and the second film layer is provided with a plurality of second through-holes in one-to-one correspondence with the plurality of first through-holes, the second through-hole being communicated with the corresponding first through-hole; and
a plurality of color resist blocks, wherein each of the color resist blocks is disposed in one second through-holes and the corresponding first through-hole;
wherein a material of the first film laver is different from a material of the second film layer, reflectivity of the first film laver is less than a reflectivity threshold, and an optical density of the second film laver is greater than an optical density threshold.

15. A display device, comprising: a drive circuit and the display panel as defined in claim 14;
wherein the drive circuit is connected with an array substrate in the display panel, and is configured to provide a drive signal for the array substrate.

16. The display device according to claim 15, wherein the display device is a wearable display device.

17. The display panel according to claim 14, wherein an orthographic projection of the second through-hole on the base substrate covers an orthographic projection of the corresponding first through-hole on the base substrate.

18. The display panel according to claim 14, wherein the reflectivity threshold is 10%, and the optical density threshold is 4.0.

19. The display panel according to claim 14, wherein the material of the first film layer comprises an oxide material; and the material of the second film layer comprises a metal material.

20. The display panel according to claim 19, wherein the material of the first film layer comprises molybdenum oxide; and the material of the second film layer comprises at least one of molybdenum, aluminum, titanium, and copper.
